(19) United States
(12) Patent Application Publication
(10) Pub. No.: US 2010/0043684 A1
(43) Pub. Date: Feb. 25, 2010

(54) Refuse Processing and Energy Recovery System and Method

(76) Inventors: Gary Erb, Crystal Lake, IL (US); David Ross Peterson, Dixon, IL (US)

Correspondence Address: MILLER, MATTHIAS & HULL, ONE NORTH FRANKLIN STREET, SUITE 2350, CHICAGO, IL, 60606, US

(21) Appl. No.: 12/195,216

(22) Filed: Aug. 20, 2008

(51) Int. Cl. F23G 5/00; B07C 5/00

(52) U.S. Cl. 110/346; 209/630

(57) ABSTRACT

Apparatus and methods of converting refuse into energy production and useful gases include a sealed rotary gas kiln in which the refuse is volatized. Prior to entry into the kiln, the refuse may be conditioned by removing certain materials not suitable for volatilization and by reducing the physical size of the refuse into easily processed bundles. The sealed kiln includes a refuse inlet, a post-volatilization solids outlet, and an exhaust gas outlet. The kiln is sealed so that substantially all exhaust gas exits through the exhaust gas outlet. Additionally, the system may include an organic rankine cycle unit in which primarily generates power from the exhaust gas, while also separating some materials from the exhaust gas. The system may also include a separator which removes additional solids from the exhaust gas stream and separates usable gases from the exhaust gas. The materials collecting at each stage of the process may be reused internally or may be sold for external uses.

### FIELD OF THE DISCLOSURE

This disclosure generally relates to apparatus and methods for processing refuse, and more particularly to recovering energy and useful byproducts from refuse.

### BACKGROUND OF THE DISCLOSURE

Handling and disposal of refuse is an ongoing problem. The volume of organic and non-organic materials that must be disposed of on a daily basis is nearing or exceeding the capacity of many existing and proposed landfills.

Various systems have been proposed to recover energy while processing refuse into a more compact size. These systems often use a rotary kiln to incinerate the refuse, thereby reducing the solids volume of the refuse while releasing gases. The temperatures inside the kiln are typically approximately 1500 degrees Fahrenheit or more. Energy recovery is generally indirect, where heat from the gases exiting the kiln is transferred to an auxiliary system such as a steam or hot water generator, and therefore is subject to losses during heat transfer. The partially-cooled exhaust gases are then vented to atmosphere, often at temperatures of approximately 400 degrees Fahrenheit or more.

Conventional refuse processing systems suffer from several drawbacks. Such systems are generally limited to use in outdoor settings due to the excessive amount of heat they radiate and the types of gases that they may exhaust or leak into the surrounding environment. Conventional systems also either exhaust potentially harmful gases into the environment or require additional fuel to run the burner at temperatures sufficient to break down the harmful gases into basic, typically less-harmful, components. Accordingly, it is desirable to provide a refuse processing system which may be used indoors, which more efficiently produces power from heat, and/or which captures a wider range of system byproducts that may be reused in the system or profitably sold for external use.

### SUMMARY OF THE DISCLOSURE

A refuse processing system includes a rotary kiln having a first end and a second end, the rotary kiln defining a volatilization chamber. A refuse inlet is coupled to the rotary kiln first end and fluidly communicates with the rotary kiln volatilization chamber, the refuse inlet including an inlet seal configured to substantially prevent gas in the volatilization chamber from exiting through the refuse inlet. A refuse loader is disposed in the refuse inlet and configured to advance refuse into the rotary kiln volatilization chamber. A burner is coupled to the rotary kiln second end, and a solids outlet fluidly communicates with the rotary kiln volatilization chamber. The solids outlet includes an outlet seal configured to substantially prevent gas from exiting the solids outlet. An exhaust gas outlet fluidly communicates with the rotary kiln volatilization chamber.

A method of processing refuse having at least refuse solids includes reducing the refuse solids to a particulate size, feeding the refuse into a rotary kiln through a refuse inlet, and volatilizing the refuse in the kiln to obtain post-volatilization solids and exhaust gas comprising a plurality of gas components. The post-volatilization solids are transferred from the rotary kiln into a solids receptacle through a solids outlet, and the exhaust gas from the rotary kiln is transferred into an organic rankine cycle unit through an exhaust gas outlet, which generates power from the exhaust gas. The exhaust gas is then transferred to a gas separator, where the exhaust gas is separated into gas components.

### BRIEF DESCRIPTION OF THE DRAWINGS

For a more complete understanding of the disclosed methods and apparatus, reference should be made to the embodiments illustrated in greater detail on the accompanying drawings, wherein;

FIG. 1 is a schematic diagram of a refuse processing system in accordance with the present disclosure;

FIG. 2 is an enlarged schematic diagram of a sealed rotary kiln used in the system of FIG. 1;

FIG. 3 is a schematic diagram of an alternative embodiment of a sealed rotary kiln that may be used in the system of FIG. 1;

FIG. 4 is an enlarged detail of an inlet end of the sealed rotary kiln of FIG. 3;

FIG. 5 is a schematic diagram of a further embodiment of a sealed rotary kiln that may be used in the system of FIG. 1;

FIG. 6 is an enlarged detail of an inlet end of the sealed rotary kiln of FIG. 5; and

FIG. 7 is an enlarged detail of an inlet vent provided at the inlet end of the sealed rotary kiln of FIG. 5.

It should be understood that the drawings are not necessarily to scale and the disclosed embodiments are sometimes illustrated diagrammatically in partial views. In certain instances, details which are not necessary for an understanding of the disclosed methods and apparatus, or which render other details difficult to perceive, may have been omitted. It should be understood, of course, that this disclosure is not limited to the particular embodiments illustrated herein.

### DETAILED DESCRIPTION OF THE DISCLOSURE

Various embodiments of refuse processing systems are disclosed in which the physical size of the refuse is reduced in a volatilization chamber while the byproducts of volatilization are used to generate power and/or are recovered for further use, either inside or outside of the system. In certain embodiments, the system comprises three main stages: (1) an upstream stage during which refuse is aggregated and conditioned for volatilization; (2) a volatilization stage during which refuse is volatilized; and (3) a downstream stage during which volatilization byproducts are used to generate power and are separated for further use.

During the upstream stage, refuse solids are aggregated and certain types of refuse materials are removed. The refuse solids are then processed into a form suitable for volatilization, such as by chopping the refuse into a desired particulate size. Additional types of refuse, such as organic materials in liquid or solid form, may be added to the refuse solids prior to volatilization.

In the volatilization stage, the conditioned refuse is fed into a volatilization chamber, such as a rotary kiln, where the volume of the refuse solids is reduced and exhaust gases are generated. As used herein, the terms “volatilize” and “volatilization” refer to processes in which molecular bonds are broken, resulting in molecules separating into their individual elements in vapor form and an exothermic release of energy. In the present disclosure, volatilization may occur in a “starved oxygen” environment, in which little or no oxygen is present. To the extent some oxygen is present in the chamber, a limited level of combustion may also occur. The reduced refuse solids are generally in the form of ash or clinker, which is discharged from the volatilization chamber and collected for external use, such as filler for concrete. The exhaust gases are transferred to downline equipment used in the final stage. The volatilization chamber may have a refuse inlet and a solids outlet that are substantially airtight to ensure that substantially all of the exhaust gas is directed through the exhaust gas outlet and does not leak into the surrounding environment. Additionally, an exterior heat exchanger may be provided which reduces the amount of heat radiated to the surrounding environment. Reduction of exhaust gas leakage and heat radiated from the volatilization chamber make the system more feasible for indoor use.

In the downstream stage, the exhaust gases are used to generate power and are ultimately separated for use either internally or externally. A power generator, such as an organic rankine cycle unit that may generate electrical or mechanical power, receives the heated exhaust gas from the volatilization chamber and generates power therefrom. A gas separator then receives the exhaust gas from the generator and separates it into constituent gases, such as carbon dioxide, synthetic gas, and hydrogen. The constituent gases may be reused in the volatilization chamber or may be collected for use or sale off-site.

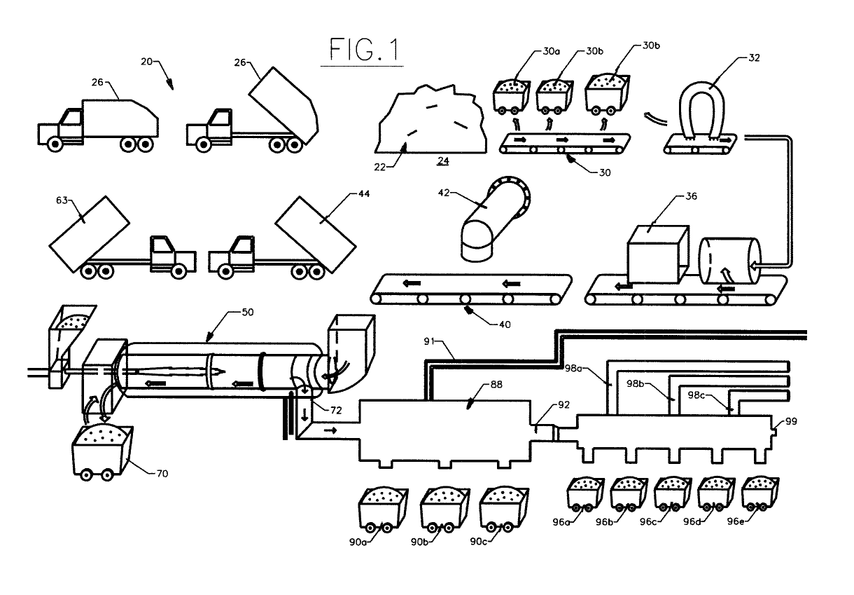

FIG. 1 illustrates a refuse processing system 20 including the aforementioned upstream, volatilization, and downstream stages. In the upstream stage, unconditioned refuse 22 is aggregated at a waste site 24. The unconditioned refuse 22 may include household garbage, pharmaceutical waste, paints, oils, industrial waste, construction debris, wood waste, hazardous waste, medical waste, used tires, sewage sludge, or any other material commonly disposed in landfills. The unconditioned refuse 22 may be generated on-site, or may be transported to the waste site 24 by vehicles such as dump trucks 26.

The unconditioned refuse 22 is placed into a preliminary material separator 30, which removes specific materials from the refuse 22 that are not suitable for volatilization. For example, the separator 30 may be configured to remove batteries and glass from the unconditioned refuse 22 and discharge these materials in collection bins 30a, 30b, respectively. The separator 30 may further include a magnetic separating unit 32 which removes metals to a collection bin 30c.

The preliminarily separated refuse is then transferred to a reducing unit which processes solids in the refuse into a size suitable for volatilization. In an exemplary embodiment, the reducing unit is a chopping station 36 which cuts the refuse solids into a desired size. The desired size may be selected according to the volatilization parameters. For example, the refuse may be chopped into bundles that are approximately two inch cubes (i.e., two inches high, by two inches wide, by two inches deep), however other bundle sizes may be used without departing from the scope of this disclosure.

From the reducing unit, the chopped refuse bundles are transferred to a final materials conveyor 40 in which organic refuse may be added to the bundles. For example, sanitary sewage sludge may be deposited onto the bundles from a sludge pipe 42, while other organic materials may be added from a dump truck 44. After the optional addition of organic materials, the refuse is fully conditioned and ready for volatilization.

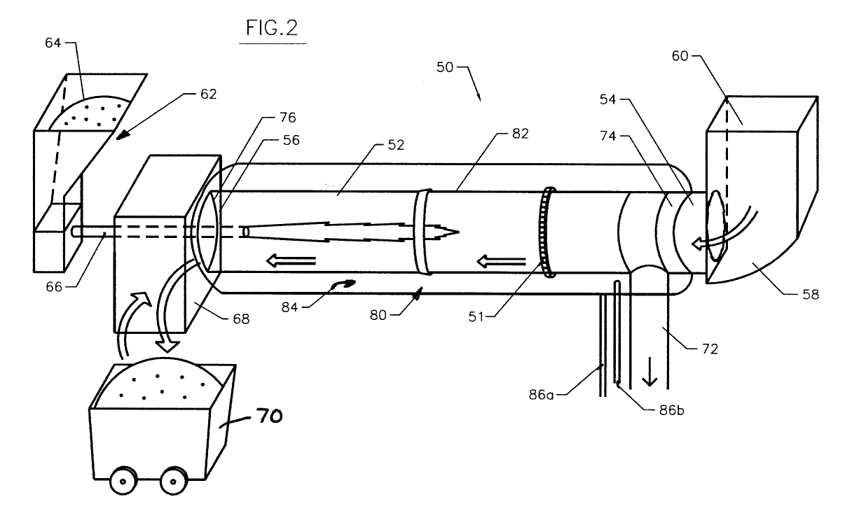

The volatilization stage may be performed in a volatilization chamber, such as that defined by a rotary kiln 50 as shown in FIG. 1. Rotary kilns are generally known in the art, and therefore only those structures that are necessary for an understanding of the present disclosure are discussed herein. In the embodiment illustrated in FIGS. 1 and 2, the rotary kiln 50 includes a side wall 52 defining a volatilization chamber 53 and having a first end 54 and a second end 56. The side wall 52 may be inclined, so that the first end 54 is raised with respect to the second end 56. A refuse inlet hopper 58 is coupled to the kiln first end 54 and includes an inlet 60 for receiving the conditioned refuse.

A burner assembly 62 is coupled to the kiln second end 56 and includes a fuel hopper 64 for receiving fuel for volatilization. A burner pipe 66 has a first end in fluid communication with the fuel hopper 64 and a second end disposed in the volatilization chamber 53. The burner assembly 62 may use any type of fuel, including coal fines delivered by truck 63, to generate volatilization in the chamber 53.

A solids outlet 68 for discharging post-volatilization solids to a solids receptacle 70 is also coupled to the kiln second end 56. An exhaust gas outlet 72 has a first end coupled to the kiln first end 54. The refuse inlet hopper 58 and solids outlet 68 are preferably configured to prevent exhaust gases from leaking to the exterior environment, so that substantially all of the exhaust gas exits the volatilization chamber 53 through the gas outlet 72. First and second seals 74, 76 are schematically shown in FIG. 2 to generally illustrate a sealed rotary kiln in which substantially all of the exhaust gas exits through the outlet 72.

During operation, the burner assembly 62 is operated to generate a temperature in the volatilization chamber 53 sufficient at least initiate volatilization of the refuse. The working temperatures inside the chamber 53 may be approximately 900-2,000 degrees Fahrenheit, however the actual temperature inside the chamber may fall outside this range. With the volatilization chamber 53 at its operating temperature, refuse may be introduced into the chamber 53. The burner assembly 62 supplies sufficient heat to initiate volatilization. Once volatilization of the refuse begins, exothermic energy released by the breaking of molecular bonds in the refuse should be sufficient to maintain the desired temperature inside the chamber 53, and therefore the burner assembly 62 should not be required to operate thereafter. It is possible, however, that the chamber temperature will drop below a minimum required temperature, at which time the burner assembly 62 may be operated to raise the chamber temperature.

The side wall 52 of the kiln 50 may be rotated (such as by external gear 51), to advance the refuse from the first end 54 to the second end 56 of the kiln 50. The kiln 50 may be rotated so that the refuse remains in the volatilization chamber 53 for a desired residence period. The residence period may be inversely proportional to the chamber temperature, and may also take other factors into consideration such as refuse content and physical size. During volatilization, the volume of the refuse is substantially reduced and constituent gases are released. Any remaining post-volatilization solids are discharged through the solids outlet 68, typically in the form of ash and/or clinker, which may be used as a filler for concrete. Heat from the exiting ash/clinker may be returned to the volatilization chamber 53 to improve efficiency of the system. Meanwhile, the exhaust gas is directed through the gas outlet 72 for use in the downstream stage.

The rotary kiln 50 may further include an external heat exchanger to recover heat from an exterior of the kiln while reducing the amount of heat radiated to the surrounding environment. In the illustrated embodiment, a thermal exchange blanket 80 is disposed around an exterior surface 82 of the kiln 50. The blanket 80 defines an annular chamber 84 that retains a substantial portion of the heat radiating from the kiln 50. Inlet and outlet pipes 86a, 86b fluidly communicate with the annular chamber 84 and carry a heat transfer fluid, such as thermal oil, to direct the recovered heat as desired.

In the downstream stage, exhaust gas from the rotary kiln 50 is used to generate power and is ultimately separated into constituent gases for use either internally within the system or externally outside the system. In the illustrated embodiment, a power generator, such as an organic rankine cycle unit 88, receives the hot exhaust gas from the volatilization chamber 53 via the gas outlet 72. The organic rankine cycle unit 88 comprises a series of cascading closed loop heat exchangers having a heat exchange medium, such as propane, disposed therein. Heat from the exhaust gas is used to vaporize the heat exchange medium which is then expanded in multiple expansion turbines to generate useful mechanical or electrical power. In the illustrated embodiment, electrical power is delivered to outlet 91. As the exhaust gas is partially cooked in the organic rankine cycle unit 88, byproducts of nitrates, sulfates, and phosphates may be collected in respective containers 90a, 90b, and 90c. The collected byproducts may have value in other uses, such as in fertilizer. The partially cooled exhaust gas is then discharged from the organic rankine cycle unit 88 through an outlet 92. Additional details of specific embodiments of the organic rankine cycle unit 88 are provided in U.S. Pat. Nos. 6,857,268 and 7,096,665, both to Stinger et al., which are incorporated herein by reference.

A gas separator 94 has an inlet 96 in fluid communication with the outlet 92 of the organic rankine cycle unit 88. The gas separator 94 may remove one or more toxins from the exhaust gas. For example, the gas separator 94 may remove sulfur, gold, palladium, platinum, and zinc and collect these materials in receptacles 96a-e. The collected materials may then be used in other processes or sold. Additionally, the gas separator 94 may separate the exhaust gas into its constituent gases. For example, the gas separator may separate one or more substantially pure streams of carbon dioxide, synthetic gas (a carbon monoxide and hydrogen mixture), and hydrogen and discharge the constituent gases through respective outlet conduits 98a-c. Again, these constituent gases may be reused in the refuse processing system, used in other on-site processes, or sold. Residual gases not previously separated and collected are exhausted to atmosphere through outlet 99. In general, the residual gases should have a temperature no greater than approximately 200 degrees Fahrenheit, and preferably no greater than approximately 40 degrees Fahrenheit above the current ambient temperature.

From the foregoing, it will be appreciated that the system safely processes refuse to have a smaller solids volume while recovering several useful and/or valuable byproducts. The byproducts that are recovered include not only solids, but gases, which may be used in the refuse processing system itself or in other processes. Additionally, heat from the refuse processing system may be used to generate power. The sealed kiln prevents harmful gases from escaping to the surrounding environment, and the thermal blanket reduces the amount of heat radiated from the kiln, thereby facilitating use of the system indoors.

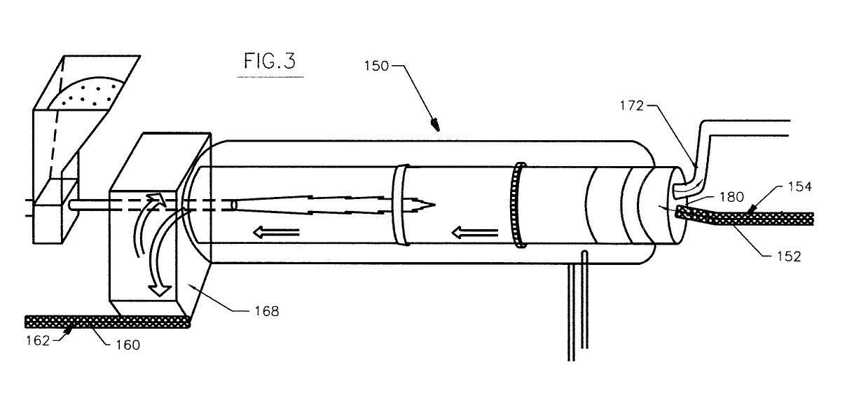

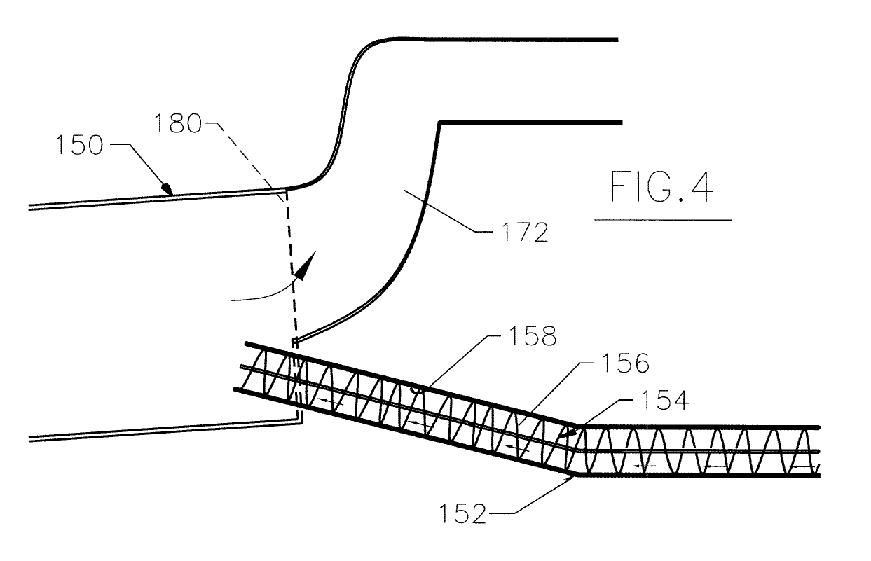

FIGS. 3 and 4 illustrate an alternative embodiment of a rotary kiln 150. The rotary kiln 150 is similar to the kiln 50 of FIGS. 1 and 2 described above, except for the refuse inlet and post-volatilization solids outlet. More specifically, rather than using a hopper for the refuse inlet, a refuse inlet conduit 152 is provided. An inlet auger 154 is disposed inside the refuse inlet conduit and is supported for rotation, thereby to advance the refuse into the kiln 152. A blade 156 of the auger 154 closely fits an interior surface 158 of the refuse inlet conduit 152, thereby to prevent backflow of exhaust gas through the conduit 152. A similar solids outlet conduit 160 with outlet auger 162 is provided at the solids outlet 168. This arrangement for sealing the rotary kiln 150 permits an exhaust gas outlet 172 to be located at an end plate 180 coupled to a first end of the kiln 150, as illustrated in FIGS. 3 and 4. A source of partial vacuum, such as the inlet side of a fan (either provided separately or integrally with the downstream stage equipment), may communicate with the exhaust gas outlet 172 to ensure that substantially all exhaust gas exits through the gas outlet 172.

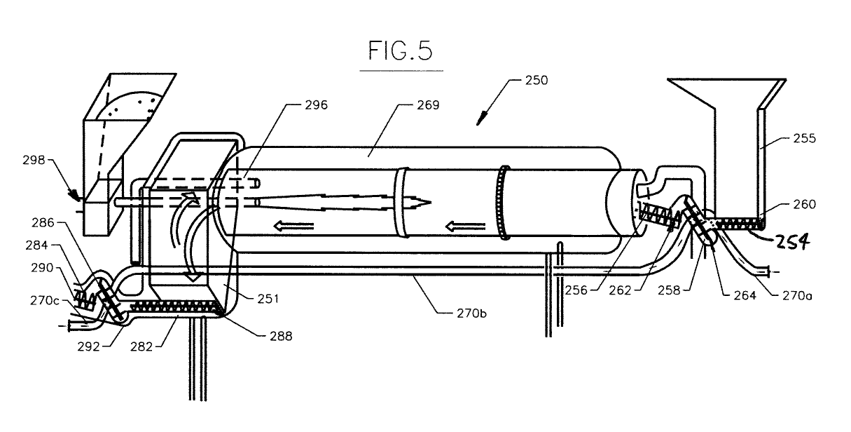

FIGS. 5-7 illustrate a further alternative embodiment of a rotary kiln 250. In this embodiment, the kiln 250 includes a refuse inlet conduit 252 having first and second segments 254, 256 with an intermediate segment 258 disposed therebetween. The first segment 254 may fluidly communicate with an inlet hopper 255 configured to receive refuse. First and second inlet augers 260, 262 are disposed in the inlet conduit first and second segments 254, 256, respectively.

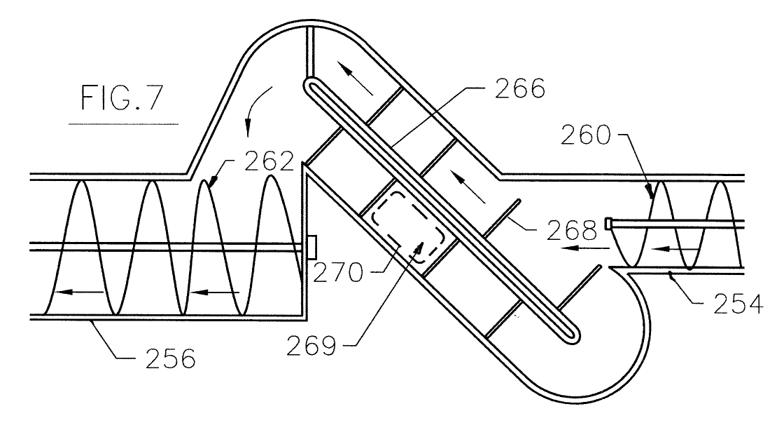

A conveyor 264 is disposed inside the inlet conduit intermediate segment 258. As best shown in FIG. 7, the conveyor 264 includes a rotating belt 266 with support arms 268 coupled thereto. An upper half of the conveyor 264 receives refuse from the first inlet auger 260, advances it along the belt 266, and discharges the refuse into the second inlet auger 262. The lower half of the conveyor 264 should be free of refuse. A blowout conduit 270 has an inlet segment 270a fluidly communicating with the inlet conduit intermediate segment 258. A blowout conduit outlet segment 270b communicates from the conduit intermediate segment 258 to an internal cavity of a thermal blanket 269. As illustrated, the thermal blanket 269 may encompass the kiln 250 as well as an outlet hopper 251. A blower (not shown) may be coupled to the blowout conduit first segment 270a to direct any exhaust gas present in the intermediate segment 258 to the blowout conduit outlet segment 270b, thereby preventing exhaust gas from escaping out through the inlet conduit 252. The blowout conduit outlet segment 270b may fluidly communicate with an air feed pipe 296 provided with a burner assembly 298.

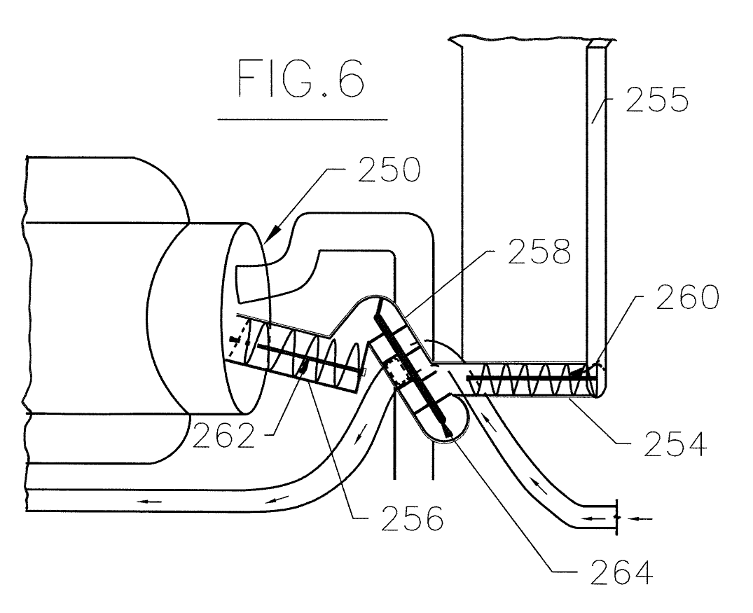

A similar auger and conveyor arrangement may be provided at the solids outlet end of the kiln 250. As shown in FIG. 5, a post-volatilization solids outlet conduit 280 includes first and second segments 282, 284 with an intermediate segment 286 disposed therebetween. The first segment 282 may fluidly communicate with the outlet hopper 251. First and second outlet augers 288, 290 are disposed in the outlet conduit first and second segments 282, 284 respectively. An outlet conveyor 292 is disposed inside the outlet conduit intermediate segment 286 and is constructed similarly to the inlet conveyor 264. An upper half of the outlet conveyor 292 receives post-volatilization solids from the first outlet auger 288 and discharges the solids into the second outlet auger 290. Another blowout conduit inlet segment 290c similar to that used with the inlet conduit 252 may also be provided, and the blowout conduit outlet segment 290b may also communicate with the intermediate segment 286 to prevent exhaust gas from traveling through the outlet conduit 280 to the surrounding environment. The thermal blanket 269 may extend over the outlet conduit 280 as shown in FIG. 6 to recover heat from the post-volatilization solids.

While only certain embodiments have been set forth, alternatives and modifications will be apparent from the above description to those skilled in the art. These and other alternatives are considered equivalents and within the scope of this disclosure and the appended claims.

What is claimed is:

1. A refuse processing system comprising:
a rotary kiln having a first end and a second end, the rotary kiln defining a volatilization chamber;
a refuse inlet coupled to the rotary kiln first end and fluidly communicating with the rotary kiln volatilization chamber, the refuse inlet including an inlet seal configured to substantially prevent gas in the volatilization chamber from exiting through the refuse inlet;
a refuse loader disposed in the refuse inlet and configured to advance refuse into the rotary kiln volatilization chamber;
a burner coupled to the rotary kiln second end;
a solids outlet fluidly communicating with the rotary kiln volatilization chamber, the solids outlet including an outlet seal configured to substantially prevent gas from exiting the solids outlet; and
an exhaust gas outlet fluidly communicating with the rotary kiln volatilization chamber.

2. The refuse processing system of claim 1, in which the refuse loader comprises an inlet auger.

3. The refuse processing system of claim 2, in which the refuse loader further comprises an inlet conveyor disposed in an intermediate inlet conduit.

4. The refuse processing system of claim 3, in which a blowout conduit has a first end fluidly communicating with the intermediate inlet conduit.

5. The refuse processing system of claim 4, in which the blowout conduit further has a second end fluidly communicating with the rotary kiln volatilization chamber.

6. The refuse processing system of claim 1, further comprising a power generator having an inlet in fluid communication with the exhaust gas outlet.

7. The refuse processing system of claim 6, in which the power generator comprises an organic rankine cycle unit.

8. The refuse processing system of claim 6, further comprising a gas separator having an inlet fluidly communicating with a gas outlet of the power generator.

9. The refuse processing system of claim 8, in which the gas separator is configured to separate the exhaust gas into constituent gas components.

10. A method of processing refuse including at least refuse solids, the method comprising:
reducing the refuse solids to a particulate size;
feeding the refuse into a rotary kiln through a refuse inlet;
volatilizing the refuse in the kiln to obtain post-volatilization solids and exhaust gas comprising a plurality of gas components;
transferring the post-volatilization solids from the rotary kiln into a solids receptacle through a solids outlet;
transferring the exhaust gas from the rotary kiln into an organic rankine cycle unit through an exhaust gas outlet;
generating power in the organic rankine cycle unit from the exhaust gas;
transferring the exhaust gas from the organic rankine cycle unit to a gas separator; and
separating the exhaust gas in the gas separator into the gas components.

11. The method of claim 10, further comprising feeding at least one of the gas components into the rotary kiln to promote volatilization.

12. The method of claim 10, further comprising collecting at least one of the gas components in a gas receptacle.

13. The method of claim 10, in which a chopping unit is used to reduce the refuse solids, and in which the particulate size is approximately two inch cubes.

14. The method of claim 10, in which the refuse inlet and solids outlet are substantially air tight so that substantially all of the exhaust gas exits through the exhaust gas outlet.

15. The method of claim 10, in which the refuse inlet comprises a sealed inlet auger configured to feed the refuse into the rotary kiln.

16. The method of claim 15, in which the solids outlet comprises a sealed outlet auger configured to transfer the post-volatilization solids from the rotary kiln into the solids receptacle.

17. The method of claim 10, further comprising surrounding an exterior surface of the rotary kiln with a heat exchanger, wherein the heat exchanger transfers heat from the rotary kiln exterior surface to an external use.

18. The method of claim 10, further comprising, prior to reducing the refuse solids to a particulate size, removing from the refuse at least one refuse material selected from the group of refuse materials consisting of batteries, glass, and metal.

19. The method of claim 10, further comprising, prior to volatilizing the refuse in the kiln, adding an organic refuse material to the refuse solids.
